(19) United States
(12) Patent Application Publication
(10) Pub. No.: US 2010/0223877 A1
(43) Pub. Date: Sep. 9, 2010

(54) ROOF TRUSS SYSTEM FOR LONG SPAN AND WIDE SPACING WITH ONE-SIDED ASSEMBLY

(75) Inventors: STEVEN EUGENE O'HARA, Stillwater, OK (US); DOSS BENTON BRIGGS, Fort Gibson, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignees: THE BOARD OF REGENTS OF OKLAHOMA STATE UNIVERSITY, Stillwater, OK (US); BRIGGS RAINBOW BUILDINGS, INC., Fort Gibson, OK (US)

(21) Appl. No.: 12/716,473

(22) Filed: Mar. 3, 2010

Related U.S. Application Data
(60) Provisional application No. 61/156,974, filed on Mar. 3, 2009.

(51) Int. Cl. E04C 3/11; B23P 15/00

(52) U.S. Cl. 52/636; 29/897.31

(57) ABSTRACT

A roof truss and method of assembly. The roof truss of the invention has a first layer of top chord members and a bottom chord, a second layer of web members, and a third layer of top chord members and a bottom chord. The second layer is affixed to the first layer with first layer fasteners and the third layer is affixed to said second layer with second layer fasteners. The first layer fasteners pass through the second layer to engage the first layer from a first side of the roof truss and the second layer fasteners pass through the third layer to engage the second layer from the first side of the roof truss. Therefore, the truss components may be field assembled without having to turn the partially assembled truss. The use of common components and fasteners and the ease of assembly provide an economical alternative to known truss systems.

### CROSS REFERENCE TO RELATED APPLICATIONS

This application claims the priority of U.S. Provisional Patent Application No. 61/156,974 entitled “ROOF TRUSS SYSTEM FOR LONG SPAN AND WIDE SPACING WITH ONE-SIDED ASSEMBLY,” filed Mar. 3, 2009, the contents of which are hereby incorporated by reference.

### STATEMENT REGARDING FEDERALLY SPONSORED RESEARCH OR DEVELOPMENT

This invention was made with government support under Grant No. SBAHQ-05-I-0061 awarded by the U.S. Small Business Administration. The government has certain rights in the invention.

### FIELD OF THE INVENTION

This invention relates to a roof truss and method of assembly of the roof truss. In more particular, the roof truss of the invention is an assembly of readily available and low cost materials and fasteners that may be easily field assembled from one side of the truss.

### BACKGROUND OF THE INVENTION

A roof truss is a collection of structural elements, attached together to support a large load imposed by a roof of a building. A typical configuration of a roof truss is generally triangular is shape wherein a bottom chord and two sloped top chords form the perimeter of the truss. A plurality of vertical or diagonal webs may be located within the truss for additional support. Trusses are typically placed parallel to one another to form a support structure for a roof.

Since trusses may be large and unwieldy, it is advantageous to be able to assemble a truss at a work site rather than transporting assembled trusses. Shipping costs for a bulky pre-assembled truss are significantly greater than shipping costs associated with shipping truss parts.

### SUMMARY OF THE INVENTION

The building roof truss of the invention is an assembly of readily available members, such as cold-rolled steel cross sections. In a preferred embodiment, the truss uses two C sections for the top and bottom chords and C or HAT sections for the webs. The C and/or HAT sections are configured for ease of assembly of the roof truss from one side. The truss of the invention is capable of longer roof spans and wider spacing than prior art trusses. The truss of the invention can achieve spans of approximately 50 feet with truss spacings of up to 10 feet. In contrast, typical known light gauge trusses span approximately 50 feet with 2 or 4 foot truss spacing. The difference in material cost and labor is therefore significant.

### BRIEF DESCRIPTION OF THE DRAWINGS

FIGS. 1A and 1B are elevation views of an assembled roof truss of the invention;

FIG. 2 is a cross-sectional view of the roof truss of FIG. 1, taken along line 2-2 of FIG. 1A;

FIG. 3 a cross-sectional view of the roof truss of FIG. 1, taken along line 3-3 of FIG. 1B;

FIG. 4 is an enlarged perspective view of a partially assembled joint where a web member is affixed to a chord;

FIG. 5 is an enlarged perspective view of an assembled joint where a web member is affixed between two adjacent chords.

### DETAILED DESCRIPTION OF THE PREFERRED EMBODIMENTS

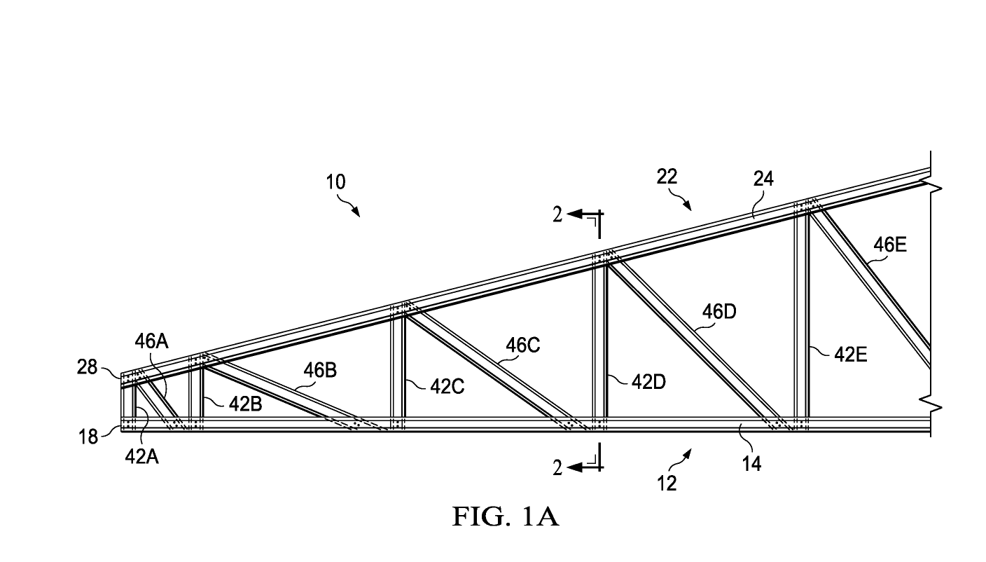

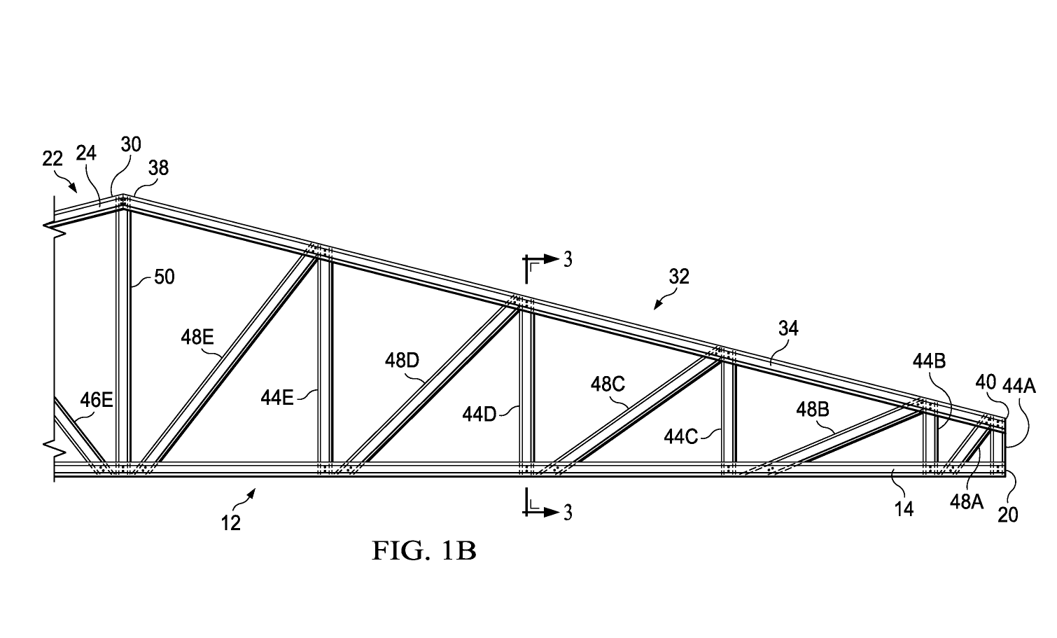

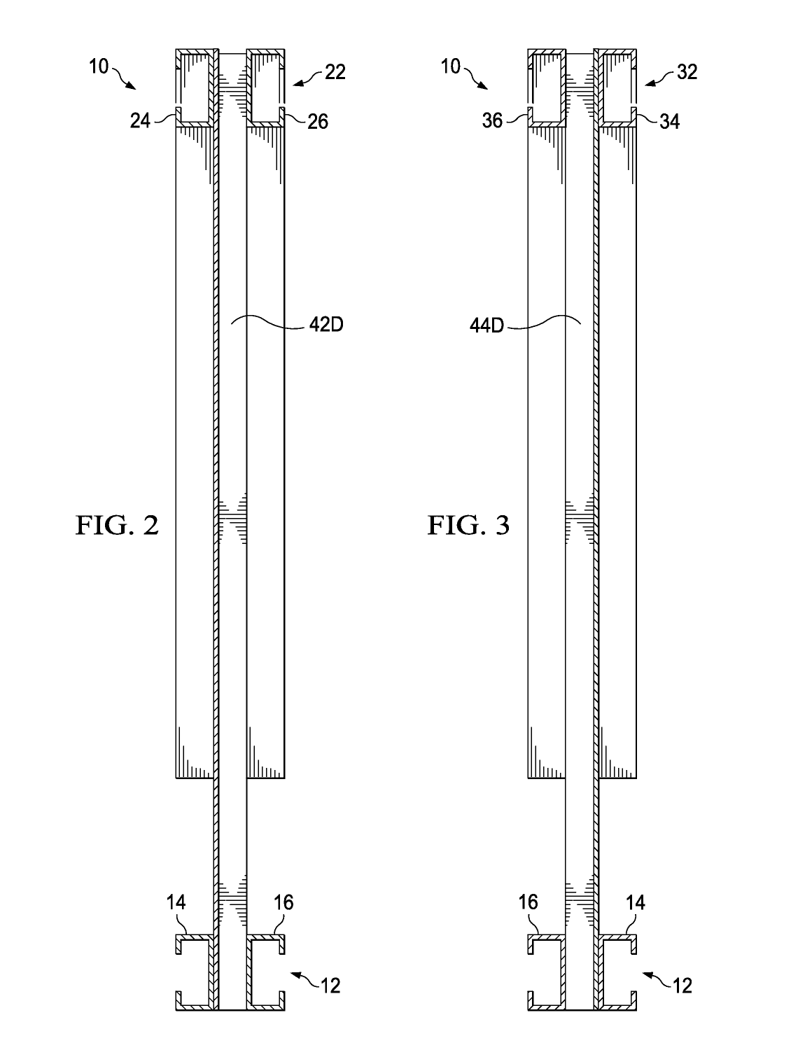

Referring to FIGS. 1-5, shown is a roof truss 10 of the invention. Roof truss 10 has a bottom chord 12 that has a first member 14 and a second member 16 (FIGS. 2, 3). First member 14 and second member 16 of bottom chord 12 are preferably open access beams, i.e., beams having an open or recessed face. In a preferred embodiment, c-channels are used, wherein the c-channels are positioned in a back-to-back orientation, i.e., wherein the open face of the c-channels are facing away from one another. Bottom chord 12 has a first end 18 and a second end 20 (FIGS. 1A and 1B).

Left top chord 22 has a first member 24 and a second member 26 (FIG. 2). First member 24 and second member 26 of left top chord 22 are preferably c-channels that are positioned in a back-to-back orientation. Left top chord 22 has a first end 28 and a second end 30. First end 28 of left top chord 22 is proximate first end 18 of bottom chord 12.

Right top chord 32 has a first member 34 and a second member 36. First member 34 and second member 36 of right top chord 32 are preferably c-channel beams that are positioned in a back-to-back orientation. Right top chord 32 has a first end 38 and a second end 40. Second end 40 of right top chord 32 is proximate second end 20 of bottom chord 12.

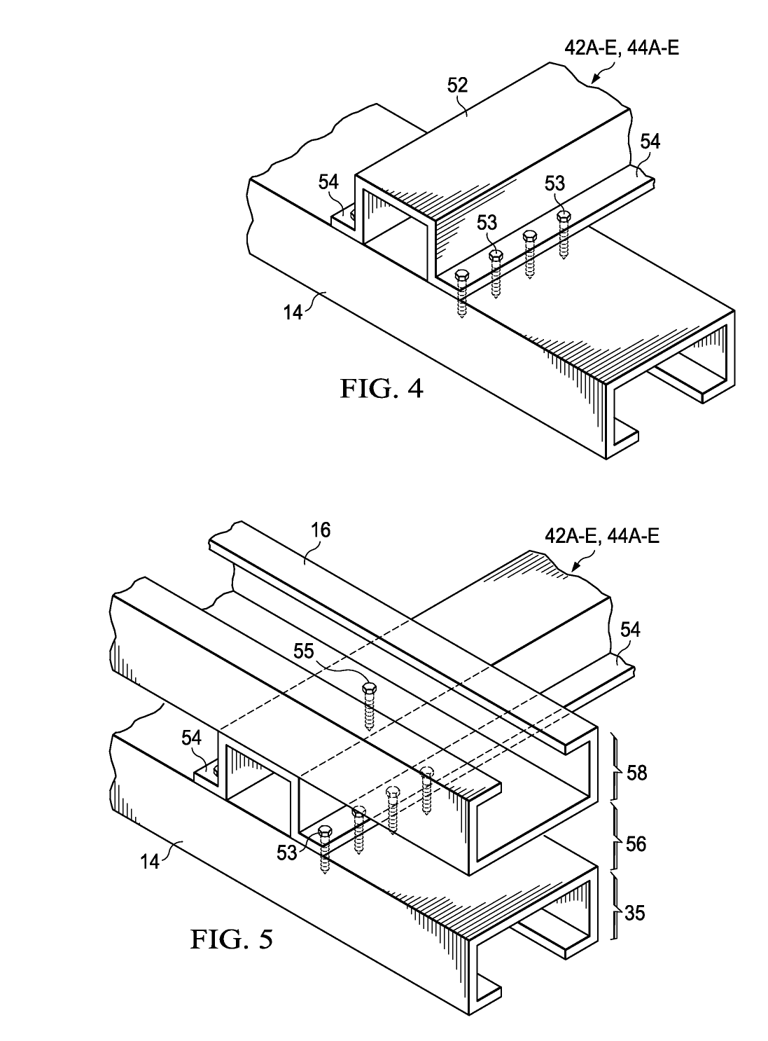

A plurality of left vertical web members 42A-42E span between bottom chord 12 and left top chord 22. A plurality of right vertical web members 44A-44E span between bottom chord 12 and right top chord 22. Left vertical web members 42A-42E and right vertical web members 44A-44E preferably have a hat shaped cross section (see FIGS. 4, 5) but may be constructed of any suitable open access beam.

A plurality of left diagonal web members 46A-46E span between bottom chord 12 and right top chord 22. A plurality of right diagonal web members 48A-48E span between bottom chord 12 and left top chord 32. Left diagonal web members 46A-46E and right diagonal web members 48A-48E preferably have a hat shaped cross section, but may be constructed of any suitable open access beam.

A central vertical web member 50 spans between bottom chord 12 and a second end 30 of left top chord 22 and a first end 38 of right top chord 32. Central vertical web member 50 preferably has a hat shaped cross section, but may be constructed of any suitable open access beam.

In a preferred embodiment, the hat shaped cross section of each of left vertical web members 42A-42E, right vertical web members 44A-44E, left diagonal web members 46A-46E, right diagonal web members 48A-48E, and central vertical web member 50, is configured to have a central web surface 52 and a pair of flange surfaces 54 (FIG. 4).

Referring now to FIGS. 2 and 3, roof truss 10 of the invention is substantially symmetrical since major components, such as first member 14 and second member 16 of bottom chord 12 are provided on both a right and left side of web members 42A-42E, 44A-44E, 46A-46E, 48A-48E, and 50. Similarly, left top chord 22 and right top chord 32 are assembled from first members 24, 34, and second members 26, 36, which are configured in a back-to-back configuration that is symmetrical about web members 42A-42E, 44A-44E, 46A-46E, 48A-48E, and 50, as shown in FIGS. 2 and 3. Roof truss 10 may not be perfectly symmetrical since web members 42A-42E, 44A-44E, 46A-46E, 48A-48E, and 50 preferably are hat sections, which are not symmetrical when comparing a top side, i.e., a web side, and a bottom side, i.e., a flange side.

To assemble roof truss 10 of the invention, first member 14 of bottom chord 10 is placed on a surface. In a preferred embodiment, first member 14 of bottom truss chord 10 is a C channel beam, wherein the C channel beam is positioned open side down, i.e., web side up.

First member 24 of left top chord 22 is also placed on the surface wherein first end 28 is located proximate to first end 18 of first member 14 of bottom truss chord 10. The first member 24 of left top chord 32 is preferably a C channel beam, wherein the C channel beam is positioned open side down, i.e., web side up.

Additionally, first member 34 of right top chord 32 is placed on the surface wherein second end 40 is located proximate to second end 20 of first member 14 of bottom truss chord 10. The first member 34 of right top chord 32 is preferably a C channel beam, wherein the C channel beam is positioned open side down, i.e., web side up.

First member 14, first member 24 and first member 34 make up first layer 35 (FIG. 5) of roof truss 10.

Next, first ends of left vertical web members 42A-42E, e.g., hat channel beams, are placed on first member 14 of bottom truss chord 12. In a preferred embodiment, left vertical web members 42A-42E have a pair of flange surfaces 54 and a web or central surface 52. Second end of left vertical web members 42A-42E are placed on first member 24 of left chord 22.

First ends of right vertical web members 44A-44E, e.g., hat channel beams, are placed on first member 14 of bottom truss chord 12. In a preferred embodiment, right vertical web members 44A-44E have a pair of flange surfaces 54 and a web or central surface 52. Second ends of right vertical web members 42A-42E are placed on right chord 32.

First ends of left diagonal web members 46A-46E, e.g., hat channel beams, are placed on first member 14 of bottom truss chord 12. In a preferred embodiment, left diagonal web members 46A-46E have a pair of flange surfaces 52 and a web or central surface 54. Second ends of left diagonal web members 46A-46E are placed on first member 24 of left chord 22.

First ends of right diagonal web members 48A-48E, e.g., hat channel beams, are placed on first member 14 of bottom truss chord 12. In a preferred embodiment, right diagonal web members 48A-48E have a pair of flange surfaces 54 and a web or central surface 52. Second ends of right diagonal web members 48A-48E are placed on first member 34 right chord 32.

A first end of central vertical web member 50, e.g., a hat channel beam, is placed on first member 14 of bottom truss chord 12. In a preferred embodiment, central vertical member 50 has a pair of flange surfaces 54 and a web or central surface 52. A second end of central vertical member 50 is placed on second end 30 of first member 24 and on first end 38 of first member 24.

In a preferred embodiment, first ends of left vertical web members 42, right vertical web members 44, left diagonal web members 46, right diagonal web members 48 and central vertical web member 50 are secured to first member 14 of bottom chord 12 by securing one of the hat channel flange surfaces 54 and the hat channel web or central surface 52 to the C channel web of the first member 14 of bottom truss chord 12 with first layer fastener 53 (flange surfaces 54 shown affixed to first member 14 in FIGS. 4 and 5). Fasteners 53 are preferably screws. However, other fasteners may also be used. Screws and other fasteners preferably have a head and a shank.

Second ends of left vertical web members 42 and left diagonal web members 46 are secured to first member 24 of left top chord 22 by securing one of the hat channel flange surfaces 54 and the hat channel web or central surface 52 to the C channel web of the first member 24 of left top chord 22 with first layer fastener 53.

Second ends of right vertical web members 44 and right diagonal web members 48 are secured to first member 34 of right top chord 32 by securing one of the hat channel flange surfaces 54 and the hat channel web or central surface 52 to the C channel web of first member 34 of right top chord 32 with first layer fastener 53.

Second end of central vertical member 50 is secured to the ends of left top chord 22 and right top chord 32 by securing one of said hat channel flange surfaces 54 and hat channel web surface 52 with first layer fastener 53.

Left vertical web members 42A-42E, right vertical web members 44A-44E, left diagonal web member 46A-46E, right diagonal web member 48A-48E and central vertical member 50 make up second layer 56 (FIG. 5) of roof truss 10.

Second member 16 of bottom truss chord 12 is placed on first ends of web members 42A-42E, 44A-44E, 46A-46E, 48A-48E. Second member 16 of bottom truss chord 12 is preferably made of a C channel beam, wherein the C channel beam is positioned open side up, i.e., web side down.

Second left member 26 of left top chord 22 is placed on the second ends of web members 42A-42E, 46A-46E. Second left member 26 of left top truss chord 22 is preferably made of a C channel beam, wherein the C channel beam is positioned open side up, i.e., web side down.

Second ends of web members 42A-42E, and 46A-46E are secured to second member 26 of left top truss chord 22 and second ends 44A-44E and 48A-48E are secured to second member 36 of right truss chord 32 by securing one of the hat channel flange surfaces 54 and the hat channel web surface 52 to the C channel web of second member 26 of left top truss chord 22 and second member 36 of right top chord 32 with second layer fastener 55 (FIG. 5).

Second right member 36 of right top truss chord 32 is placed on the second ends of web members 44A-44E, 48A-48E. Second right member 36 of right top truss chord 32 is preferably a C channel beam, wherein the C channel beam is positioned open side down, i.e., web side up.

Second right member 36 of right top truss chord 32 is secured to the second end of web members 44A-44E, 48A-48E by securing one of the hat channel flange surfaces 54 and hat channel web surfaces 52 to the second member 36 of right top truss chord 32 with second layer fastener 55.

The assembly made up of second member 16, second member 26 and second member 36 makes up third layer 58 (FIG. 5) of roof truss 10.

Fasteners 53, 55 are applied from one side of truss assembly 10, thereby eliminating a need to flip truss assembly 10 during the assembly phase. Fasteners 53, 55 may be readily available fasteners including bolts, screws or other inexpensive fasteners.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A roof truss comprising:
a first layer comprised of top chord members and a bottom chord;
a second layer comprised of web members;
a third layer comprised of top chord members and a bottom chord;
wherein said second layer is affixed to said first layer with first layer fasteners; and
wherein said third layer is affixed to said second layer with second layer fasteners.

2. The roof truss according to claim 1 wherein:
said first layer fasteners and said second layer fasteners have a head and shank;
said head of said first layer fasteners engages a first side of said second layer as a result of said first layer fasteners passing through said second layer and engaging said first layer; and
said head of said second layer fasteners engages a first side of said third layer as a result of said second layer fasteners passing through said third layer and engaging said second layer.

3. A roof truss comprising:
a bottom chord having a first open access beam adjacent to a second open access beam in a back-to-back configuration, said bottom chord having a left end and a right end;
a left top chord having a first open access beam adjacent to a second open access beam in a back-to-back configuration, said left top chord having a left end and a right end, said left end of said left top chord proximate to said left end of said bottom chord;
a right top chord having a first open access beam adjacent to a second open access beam in a back-to-back configuration, said right top chord having a left end and a right end, said right end of said right top chord proximate to said right end of said bottom chord;
a plurality of left web members spanning between said bottom chord and said left top chord, said left vertical web members comprised of open access beams;
a plurality of right web members spanning between said bottom chord and said right top chord, said right web members comprised of open access beams;
a central web member spanning between said bottom chord and said right end of said left top chord and a left end of said right top chord, said central vertical web member comprised of an open access beam.

4. The roof truss according to claim 3 wherein:
said first open access beam of said bottom chord is a C channel beam;
said second open access beam of said bottom chord is a C channel beam;
said first open access beam of said left top chord is a C channel beam;
said second open access beam of said left top chord is a C channel beam;
said first open access beam of said right top chord is a C channel beam;
said second open access beam of said right top chord is a C channel beam.

5. The roof truss according to claim 3 wherein:
said left vertical web members have a hat-shaped cross-section;
said right vertical web members have a hat-shaped cross-section;
said central vertical web member has a hat-shaped cross-section;
wherein said hat-shaped cross-section of said left vertical web member, said right vertical web member and said central vertical web member, have a center surface, a first extending surface and a second extending surface.

6. A method of truss assembly comprising the steps of:
placing a first layer on a surface;
placing a second layer on said first layer;
securing said second layer to said first layer with a first layer fastener;
placing a third layer on said second layer;
securing said third layer to said second layer with a second layer fastener;
wherein said first layer fastener passes through said second layer and engages said first layer from a first side; and
wherein said second layer fastener passes through said third layer and engages said second layer from said first side.

7. A method of assembling a roof truss comprising the steps of:
placing a first bottom truss chord on a surface, said first bottom truss chord comprising a first open access beam, wherein said first open access beam is positioned open side down, web side up;
placing a first right top truss chord on said surface, said first right top truss chord comprising a first right open access beam, wherein said first right open access beam is positioned open side down, web side up;
placing a first left top truss chord on said surface, said first left top truss chord comprising a first left open access beam, wherein the first left open access beam is positioned open side down, web side up;
placing a first end of a left web member on said first bottom truss chord;
placing a second end of said left web member on said first left top truss chord;
placing a first end of a right web member on said first bottom truss chord;
placing a second end of said right web member on said right top truss chord;
securing said first end of said left web member to said first bottom truss chord with a first layer fastener;
securing said second end of said left web member to said left top truss chord with a first layer fastener;
placing a second bottom truss chord on said first end of said right web member and on said first end of said left web member, said second bottom truss chord made of a second open access beam, wherein said second open access beam is positioned open side up, web side down;
placing a second right top truss chord on said second end of said right web member, said second right top truss chord made of a second right open access beam, wherein the second right open access beam is positioned open side up, web side down;
placing a second left top truss chord on said second end of said left web member, said second left top truss chord made of a second left open access beam, wherein the second left open access beam is positioned open side up, web side down;
securing said second bottom truss chord to said first end of said right web member and to said first end of said left web member with a second layer fastener;
securing said second right top truss chord to said second end of said right web member and to said second end of said left web member with a second layer fastener;
wherein said first layer fasteners and said second layer fasteners are applied from a first side of the truss assembly but not from a second side of the truss assembly.
